(19) United States
(12) Patent Application Publication
(10) Pub. No.: US 2025/0286589 A1
(43) Pub. Date: Sep. 11, 2025

(54) METHOD AND DEVICE FOR DETERMINING CHANNEL STATE INFORMATION (CSI)

(71) Applicant: Beijing Xiaomi Mobile Software Co., Ltd., Beijing (CN)

(72) Inventor: Mingju LI, Beijing (CN)

(73) Assignee: Beijing Xiaomi Mobile Software Co., Ltd., Beijing (CN)

(21) Appl. No.: 18/859,477

(22) PCT Filed: Apr. 25, 2022
(86) PCT No.: PCT/CN2022/089126

§ 371 Date: Oct. 23, 2024

(51) Int. Cl. H04B 7/06; H04B 7/0417

(52) U.S. Cl. CPC H04B 7/0617; H04B 7/0417

(57) ABSTRACT

A method and device for determining channel state information (CSI) are provided. The method includes: receiving uplink pilot signals sent by a terminal at T consecutive moments; performing uplink channel estimation on the uplink pilot signals to determine uplink channel information at each moment, wherein T is an integer greater than 1; determining a channel state information reference signal (CSI-RS) beam according to the uplink channel information; sending a beamformed CSI-RS to the terminal according to the CSI-RS beam; and receiving CSI reported by the terminal.

### CROSS-REFERENCE TO RELATED APPLICATIONS

The present application is a U.S. National Stage of International Application No. PCT/CN2022/089126, filed on Apr. 25, 2022, the contents of all of which are incorporated herein by reference in their entirety for all purposes.

### BACKGROUND OF THE INVENTION

In a new radio (NR) system, for a Type II port selection codebook, quantized feedback of channel state information (CSI) is achieved, and a port beam of a channel state information reference signal (CSI-RS) is designed by using the reciprocity between uplink and downlink channel angles and delays in a frequency division duplex (FDD) system.

### SUMMARY OF THE INVENTION

The present disclosure relates to the technical field of communications, in particular to, a method and device for determining channel state information (CSI). A method and device for determining CSI are provided according to embodiments of the present disclosure.

In a first aspect, a method for determining channel state information (CSI) is provided according to an embodiment of the present disclosure. The method is performed by a network device and includes: receiving uplink pilot signals sent by a terminal at T consecutive moments; performing uplink channel estimation on the uplink pilot signals to determine uplink channel information at each moment, where T is an integer greater than 1; determining a channel state information reference signal (CSI-RS) beam according to the uplink channel information; sending a beamformed CSI-RS to the terminal according to the CSI-RS beam; and receiving CSI reported by the terminal.

In a second aspect, a method for determining channel state information (CSI) is provided according to another embodiment of the present disclosure. The method is performed by a terminal and includes: sending uplink pilot signals to a network device at T consecutive moments, where T is an integer greater than 1; receiving a beamformed CSI-RS sent on a CSI-RS beam by the network device, where the CSI-RS beam is determined by the network device according to uplink channel information, and the uplink channel information is determined by performing an uplink channel estimation on the uplink pilot signals by the network device; determining CSI according to the beamformed CSI-RS; and sending the CSI to the network device.

In a third aspect, a network device is provided according to an embodiment of the present disclosure. The network device includes one or more processors and a memory, and a computer program is stored in the memory; and the one or more processors execute the computer program stored in the memory to cause the network device to receive uplink pilot signals sent by a terminal at T consecutive moments; perform uplink channel estimation on the uplink pilot signals to determine uplink channel information at each moment, where T is an integer greater than 1; determine a channel state information reference signal (CSI-RS) beam according to the uplink channel information; send a beamformed CSI-RS to the terminal according to the CSI-RS beam; and receive CSI reported by the terminal.

In a fourth aspect, a terminal is provided according to an embodiment of the present disclosure. The terminal includes one or more processors and a memory, and a computer program is stored in the memory; and the one or more processors execute the computer program stored in the memory to cause the terminal to perform the method in the second aspect.

### BRIEF DESCRIPTION OF DRAWINGS

In order to explain the technical solution in embodiments of the present disclosure or the background more clearly, the accompanying drawings that need to be used in the embodiments or the background will be explained below.

FIG. 1 is an architectural diagram of a communication system according to an embodiment of the present disclosure.

FIG. 2 is a flowchart of a method for determining a beam used by a channel state information reference signal (CSI-RS) according to an embodiment of the present disclosure.

FIG. 3 is a flowchart of a method for determining transmission downlink data precoding according to an embodiment of the present disclosure.

FIG. 4 is a flowchart of a method for determining channel state information (CSI) according to an embodiment of the present disclosure.

FIG. 5 is a structural diagram of a communication device according to an embodiment of the present disclosure.

FIG. 6 is a structural diagram of a communication device according to another embodiment of the present disclosure.

FIG. 7 is a schematic structural diagram of a chip according to an embodiment of the present disclosure.

### DETAILED DESCRIPTION OF THE INVENTION

Embodiments will be described in detail here, and instances of the embodiments are shown in the accompanying drawings. When the following description refers to the accompanying drawings, unless otherwise indicated, the same numbers in different accompanying drawings indicate the same or similar elements. The implementations described in the following embodiments do not represent all implementations consistent with the present disclosure. Rather, they are merely instances of devices and methods consistent with some aspects of the present disclosure as detailed in the appended claims.

It can be understood that “a plurality of” in the present disclosure refers to two or more, and other quantifiers are similar. “And/or” describes the association relationship of associated objects, which indicates three relationships. For example, A and/or B can indicate three scenarios: the presence of A alone, the simultaneous presence of A and B, or the presence of B alone. The character “/” universally indicates that associated objects are in an “or” relationship. The singular forms “one”, “the” and “said” are also intended to include the plural forms unless the context clearly indicates otherwise.

It can be further understood that in the embodiments of the present disclosure, although the operations are described in a specific order in the accompanying drawings, it should not be understood as requiring these operations to be performed in the specific order or serial order shown, or requiring all the operations shown to be performed to achieve the desired results. Multitasking and parallel processing may be advantageous in a particular environment.

For the convenience of understanding the technical solutions of the present disclosure, some terms involved in the embodiments of the present disclosure are briefly introduced below.

### 1. Spatial Domain Basis Vector

In an embodiment of the present disclosure, a spatial domain may include a sending side spatial domain and a receiving side spatial domain, and a spatial domain basis vector may be determined according to a sending side spatial domain basis vector and a receiving side spatial domain basis vector. Each sending side spatial domain basis vector may correspond to one transmitting beam of a transmitting end device. Each receiving side spatial domain basis vector may correspond to one receiving beam of a receiving end device.

The sending side spatial domain basis vector is taken as an embodiment for explanation below, and the receiving side spatial domain basis vector is similar to the sending side spatial domain basis vector. The sending side spatial domain basis vector is usually associated with a sending side antenna array, for example, many parameters involved in an expression of the sending side spatial domain basis vector may be understood as being configured to represent different attributes of the sending side antenna array. Thus, for the convenience of understanding the sending side spatial domain basis vector involved in the embodiment of the present disclosure, the sending side spatial domain basis vector will be described below in combination with the sending side antenna array. In spite of this, those skilled in the art shall understand that the sending side spatial domain basis vector involved in the embodiment of the present disclosure is not limited to a specific antenna array. During specific implementation, a suitable antenna array may be selected according to specific requirements, and various parameters involved in the sending side spatial domain basis vector involved in the embodiment of the present disclosure are set based on the selected antenna array.

### 2. Frequency Domain Basis Vector

A frequency domain basis vector is configured to represent the variation of the channel in the frequency domain. Specifically, the frequency domain basis vector may be configured to represent the variation of the weighting coefficients of each spatial basis vector across different frequency domain units. The variation represented by the frequency domain basis vector is related to factors such as multipath delay, etc. It can be understood that, since signals may experience different transmission delays over various paths when transmitted through a wireless channel, the changes in the channel in the frequency domain caused by different transmission delays can be represented by different frequency domain basis vectors.

In an embodiment of the present disclosure, a dimension of the frequency domain basis vector is Nf, i.e., one frequency domain basis vector contains Nf elements.

Optionally, the dimension of the frequency domain basis vector may be equal to the number of frequency domain units that require CSI measurement. Since the number of frequency domain units that require CSI measurement may vary at different moments, the dimension of the frequency domain basis vector may also differ. In other words, the dimension of the frequency domain basis vector is variable.

Optionally, the dimension of the frequency domain basis vector may also be equal to the number of frequency domain units included in an available bandwidth of a terminal. The available bandwidth of the terminal may be configured by a network device. The available bandwidth of the terminal is part or all of a system bandwidth. The available bandwidth of the terminal may also be referred to as a bandwidth part (BWP), which is not limited in the embodiment of the present disclosure.

Optionally, a length of the frequency domain basis vector may further be equal to a length of signaling configured to indicate the positions and number of frequency domain units to be reported, for example, the length of the frequency domain basis vector may be equal to the number of bits of the signaling, etc. For example, in a new radio (NR), the signaling that is configured to indicate the positions and number of the frequency domain units to be reported may be signaling that is used for a reporting band. This signaling may, for example, indicate the positions and quantity of the frequency domain units to be ported in a form of a bitmap. Thus, the dimension of the frequency domain basis vector may be the quantity of bits of the bitmap.

### 3. Time Domain Basis Vector

A time domain basis vector is configured to represent the variation of a channel in a time domain. That is, the time domain basis vector is configured to represent the time-variation of the channel. The time-variation of the channel refers to the variation of a transfer function of the channel over time. The time-variation of the channel is related to factors such as Doppler shift.

In an embodiment of the present disclosure, a dimension of the time domain basis vector is Nt, i.e., one time domain basis vector contains Nt elements.

Optionally, the dimension of the time domain basis vector may be equal to the number of time domain units that require CSI measurement. Since the number of time domain units that require CSI measurement may vary at different moments, the dimension of the time domain basis vector may also differ. In other words, the dimension of the time domain basis vector is variable.

### 4. Phase Shift

In a wireless communication system, relative movement between a terminal and a network device causes Doppler shift. Since the effect of Doppler shift manifests as phase changes of the channel in the time domain. Therefore, Doppler shift may also be represented by phase shift.

### 5. Reference Signal, Reference Signal Resource and Reference Signal Resource Set

A reference signal includes but is not limited to a channel state information-reference signal (CSI-RS). A reference signal resource corresponds to at least one of a time domain resource, a frequency domain resource or a code domain resource of a reference signal. A reference signal resource set includes one or more reference signal resources.

With the reference signal resource being a CSI-RS resource as an example, the CSI-RS resource may be divided into a non-zero power (NZP) CSI-RS resource and a zero power (ZP) CSI-RS resource.

The CSI-RS resource may be via a CSI reporting setting. The CSI reporting setting may configure a CSI-RS resource set used for channel measurement (CM). Optionally, the CSI reporting setting may further configure a CSI-RS resource set used for interference measurement (IM). Optionally, the CSI reporting setting may further configure a non-zero power CSI-RS resource set used for interference measurement.

The CSI reporting setting may be configured to indicate a bandwidth, a time domain behavior of CSI reporting, a format corresponding to a report quantity and the like. The time domain behavior includes, for example, periodic, semi-persistent and aperiodic. A terminal may generate one CSI report based on one CSI reporting setting.

### 6. Channel State Information (CSI)

For example, channel state information may include at least one of a precoding matrix indicator (PMI), a rank indication (RI), a channel quality indicator (CQI), a channel state information-reference signal resource indicator (CSI-RS resource indicator, CRI) or a layer indicator (LI), etc.

To better understand a method and device for determining channel state information (CSI) disclosed by the embodiments of the present disclosure, a communication system to which the embodiments of the present disclosure applicable is described below first.

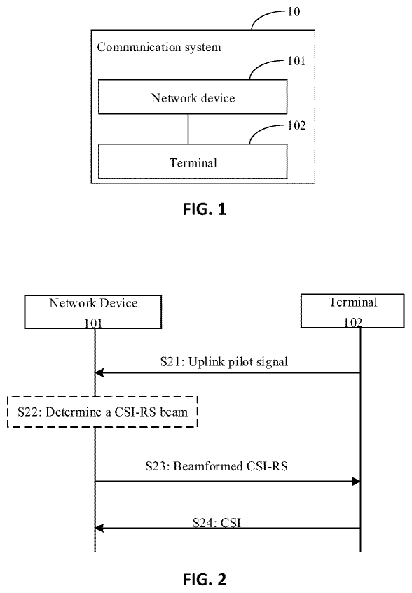

Referring to FIG. 1, FIG. 1 is a schematic architectural diagram of a communication system provided by an embodiment of the present disclosure. The communication system 10 may include, but is not limited to, one network device and one terminal, the number and form of the devices shown in FIG. 1 are for examples merely and do not constitute a limitation on the embodiments of the present disclosure, and in practical applications, it may include two or more network devices and two or more terminals. The communication system 10 shown in FIG. 1, for example, includes one network device 101 and one terminal 102.

It should be noted that the technical solution of the embodiment of the present disclosure may be applied to various communication systems, such as: a long term evolution (LTE) system, a 5th generation (5G) mobile communication system, a 5G new radio (NR) system or other new mobile communication systems in the future, etc.

The network device 101 in the embodiment of the present disclosure is an entity for transmitting or receiving signals at a network side. For example, the network device 101 may be an evolved NodeB (eNB), a transmission reception point (TRP), a next generation NodeB (gNB) in an NR system, network devices in other mobile communication systems in the future or access nodes in a wireless fidelity (WiFi) system, etc. Specific techniques and specific device forms adopted by the network device are not limited in the embodiment of the present disclosure. The network device provided by the embodiment of the present disclosure may be composed of a central unit (CU) and a distributed unit (DU), where the CU may also be referred to as a control unit, the network device, e.g., a protocol layer of the network device may be split using the CU-DU structure, functions of part of the protocol layers are controlled in a centralized mode in the CU, functions of the remaining part or all of the protocol layers are distributed in the DU, and the DU is controlled by the CU in a centralized mode.

The terminal 102 in the embodiment of the present disclosure is an entity for receiving or transmitting signals at a user side, such as a mobile phone. The terminal may also be referred to as a terminal device, a user equipment (UE), a mobile station (MS), a mobile terminal (MT), etc. The terminal may be a car with a communication function, a smart car, a mobile phone, a wearable device, a pad, a computer with a wireless receiving and transmitting function, a virtual reality (VR) terminal device, an augmented reality (AR) terminal device, a wireless terminal device in industrial control, a wireless terminal device in self-driving, a wireless terminal device in a remote medical surgery, a wireless terminal device in a smart grid, a wireless terminal device in transportation safety, a wireless terminal device in a smart city, a wireless terminal device in a smart home and the like. Specific techniques and specific device forms adopted by the terminal are not limited in the embodiment of the present disclosure.

It should be noted that the technical solutions of the embodiments of the present disclosure may be applied to various communication systems, such as: a long term evolution (LTE) system, a 5th generation (5G) mobile communication system, a 5G new radio (NR) system or other novel mobile communication systems in the future, etc. It is further to be noted that, a sidelink in the embodiments of the present disclosure may further be referred to as a side link or a direct link.

It is understandable that, the communication system 10 described in the embodiment of the present disclosure is to illustrate the technical solution of the embodiment of the present disclosure more clearly, and does not constitute a limitation on the technical solution provided by the embodiment of the present disclosure. It is known to those ordinarily skilled in the art that with the evolution of a system architecture and the appearance of new business scenarios, the technical solution provided by the embodiment of the present disclosure is also suitable for similar technical problems.

In the related art, a codebook structure of a Rel-17 Type II port selection codebook may also be W=W₁W₂W_{f}^{H}, W₁ ∈ [symbol] denotes a port selection matrix, P denotes the number of CSI-RS ports, one polarization direction is composed of L unit basis vectors, and two polarization directions use the same L unit basis vectors. The difference with a Rel-16 Type II port selection codebook is that, the terminal freely selects L=K₁/2, K₁=αP ports from P ports.

\tilde{W}₂ ∈ [symbol] denotes a combination coefficient matrix, for each layer, the number of non-zero coefficients in combination coefficient is not greater than K₀=[βK₁M], and codebook parameters α, M, β, P and N₃ are determined by a network configuration.

W_{f} ∈ [symbol] may be closed or opened, when W_{f} is closed, W_{f} is denoted by a N₃-length basis vector of which elements are all 1. When We is opened, W_{f} is composed of two N₃-length frequency domain basis vectors which contain one N₃-length basis vector of which elements are all 1. The two frequency domain basis vectors are selected from a continuous DFT window with a size of N, where N=2 or 4.

Selection or calculation of W₁, \tilde{W}₂ and W_{f} is performed by the terminal obtaining effective channel information via an estimation according to a received beamformed CSI-RS, where a beam of the CSI-RS is calculated by the network device according to estimated angle information and delay information of an uplink channel.

For a terminal moving at a medium to high speed, in order to obtain accurate precoding information, the terminal needs to report CSI with a shorter feedback period, and uplink feedback overheads are increased significantly when the CSI reporting is stilled performed using the Rel-17 Type II port selection codebook. In other words, when a terminal is moving at medium to high speed, it needs to adopt a smaller feedback period to report CSI to obtain accurate precoding information. In a case where the Type II codebook is still used for CSI reporting, the overhead of uplink feedback is significant.

Based on this, in the embodiment of the present disclosure, for the terminal moving at a medium to high speed, the network device receives uplink pilot signals sent by the terminal at a plurality of consecutive moments, Doppler shift information may be calculated according to uplink channel information estimated from the uplink pilot signals at the plurality of moments, precoding at a future moment after the plurality of moments may be further calculated according to the shift information and CSI reported by the terminal, and thus a feedback period of the terminal is shortened, and uplink feedback overhead is reduced.

Based on this, to at least solve the problems in the related art, a method and device for determining channel state information (CSI) are provided according to embodiments of the present disclosure.

Referring to FIG. 2, FIG. 2 is a flowchart of a method for determining channel state information (CSI) according to an embodiment of the present disclosure.

As shown in FIG. 2, the method is performed by a network device 101 and may include, but is not limited to, the following steps S21-S24.

S21: uplink pilot signals sent by a terminal 102 at T consecutive moments are received, and an uplink channel estimation is performed on the uplink pilot signals to determine uplink channel information at each moment, where T is an integer greater than 1.

In the embodiment of the present disclosure, the terminal may send the uplink pilot signals on a plurality of consecutive moments, and after receiving the uplink pilot signals sent by the terminal at the plurality of consecutive moments, the network device performs the uplink channel estimation on the uplink pilot signals to determine the uplink channel information at each moment.

The uplink pilot signals may be sounding reference signals (SRSs).

In some embodiments, the uplink channel information includes angle information, delay information and Doppler shift information, the angle information is denoted by a spatial domain basis vector, the delay information is denoted by a frequency domain basis vector, and the Doppler shift information is denoted by phase shift or a time domain basis vector, where determining the uplink channel information at each moment includes at least one of the following: determining a spatial domain basis vector at each moment; determining a frequency domain basis vector at each moment; determining a phase shift at each moment; or determining time domain basis vectors of the T moments.

In the embodiment of the present disclosure, after receiving the uplink pilot signals sent by the terminal at the plurality of consecutive moments, the network device performs the uplink channel estimation on the uplink pilot signals to determine the uplink channel information at each moment, and determine the angle information, the delay information and the Doppler shift information.

It should be understood that, in a frequency division duplex (FDD) system, angle information and delay information of uplink and downlink channels have reciprocity, the Doppler shift information also has reciprocity, and Doppler shift of the uplink channel is equal to Doppler shift of the downlink channel. In the embodiment of the present disclosure, the Doppler shift information at each moment is determined.

The angle information may be denoted by the spatial domain basis vector, the delay information may be denoted by the frequency domain basis vector, and the Doppler shift information may be denoted by the phase shift or the time domain basis vector.

In an embodiment, after receiving the uplink pilot signals sent by the terminal at the plurality of consecutive moments, the network device performs the uplink channel estimation on the uplink pilot signals to determine the uplink channel information at each moment, and the spatial domain basis vector at each moment may be determined.

In an example, after receiving the uplink pilot signals sent by the terminal at the plurality of consecutive moments, the network device performs the uplink channel estimation on the uplink pilot signals to determine the uplink channel information at each moment, and the frequency domain basis vector at each moment may be determined.

In an example, after receiving the uplink pilot signals sent by the terminal at the plurality of consecutive moments, the network device performs the uplink channel estimation on the uplink pilot signals to determine the uplink channel information at each moment, and the phase shift at each moment may be determined.

In an example, after receiving the uplink pilot signals sent by the terminal at the plurality of consecutive moments, the network device performs the uplink channel estimation on the uplink pilot signals to determine the uplink channel information at each moment, and the time domain basis vectors at the T moments may be determined.

In an example, after receiving the uplink pilot signals sent by the terminal at the plurality of consecutive moments, the network device performs the uplink channel estimation on the uplink pilot signals to determine the uplink channel information at each moment, and the spatial domain basis vector at each moment, the frequency domain basis vector at each moment and the phase shift at each moment may be determined.

In an example, after receiving the uplink pilot signals sent by the terminal at the plurality of consecutive moments, the network device performs the uplink channel estimation on the uplink pilot signals to determine the uplink channel information at each moment, and the spatial domain basis vector at each moment, the frequency domain basis vector at each moment, the phase shift at each moment and the time domain basis vectors at the T moments may be determined.

It should be understood that, the embodiments are not exhaustive and may be combined together for use. Further, the instances are schematic only and do not impose specific limitations on the embodiment of the present disclosure.

S22: a CSI-RS beam is determined according to the uplink channel information.

In the embodiment of the present disclosure, after receiving the uplink pilot signals sent by the terminal at the plurality of consecutive moments, the network device performs the uplink channel estimation on the uplink pilot signals to determine the uplink channel information at each moment, and determine the angle information, the delay information and the Doppler shift information.

The angle information may be denoted by the spatial domain basis vector. The delay information may be denoted by the frequency domain basis vector. The Doppler shift information may be denoted by the phase shift or the time domain basis vector.

Further, a CSI-RS beam at each moment is determined by the network device according to the spatial domain basis vector, the frequency domain basis vector and target phase shift, where the target phase shift is the phase shift or is determined according to the time domain basis vector.

In the embodiment of the present disclosure, the CSI-RS beam is determined by the network device according to the spatial domain basis vector, the frequency domain basis vector and the phase shift, the determined CSI-RS beam contains Doppler shift information, allowing for accurate precoding information to be obtained in the subsequent process, thereby meeting the demand of a terminal moving at medium to high speed for a shorter feedback period, and reducing feedback overhead.

In some embodiments, a CSI-RS beam w of the p-th transmission path at a moment t₀ is determined by the following formula: w=e^{jΔt′φ}^{ₖ}fₙ⊗sᵢ. Where si is the i-th spatial domain basis vector corresponding to the p-th transmission path, fₙ is the n-th frequency domain basis vector corresponding to the p-th transmission path, φₖ is the phase shift corresponding to the p-th transmission path, and p, i, n and k are all positive integers; and Δt′ denotes a first time difference between the moment t₀ and a first moment at which the uplink pilot signal is first received, and the first time difference is an integer multiple of a time difference between moments at which two adjacent uplink pilot signals are received.

It should be understood that, in the embodiment of the present disclosure, the CSI-RS beam w contains phase shift information, allowing for accurate precoding information to be obtained in the subsequent process, thereby meeting the demand of a terminal moving at medium to high speed for a shorter feedback period, and reducing feedback overhead.

In some embodiments, the first moment is an orthogonal frequency division multiplexing (OFDM) symbol position at which the uplink pilot signal is received at the first time before the network device sends the beamformed CSI-RS, and the time difference between the moments at which two adjacent uplink pilot signals are received is an OFDM symbol difference between OFDM symbol positions at which the two adjacent uplink pilot signals are received; or the first moment is a slot position at which the uplink pilot signal is received at the first time before the network device sends the beamformed CSI-RS, and the time difference between the moments at which the two adjacent uplink pilot signals are received is a slot difference between slot positions at which the two adjacent uplink pilot signals are received.

For example, the OFDM symbol position at which the uplink pilot signal is received at the first time before the network device sends the beamformed CSI-RS is the first OFDM symbol, and in a case where the moment to is the eighth OFDM symbol, in this case, Δt′=7, indicating that a first time difference between the eighth OFDM symbol and the first OFDM symbol is 7 OFDM symbols.

For example, the slot position at which the uplink pilot signal is received at the first time before the network device sends the beamformed CSI-RS is the first slot, and in a case where the moment to is the eighth slot, in this case, Δt′=7, indicating that a first time difference between the eighth slot and the first slot is 7 slots.

S23: the beamformed CSI-RS is sent to the terminal 102 through the CSI-RS beam.

In the embodiment of the present disclosure, the CSI-RS beam is determined by the network device according to the spatial domain basis vector, the frequency domain basis vector and the phase shift, where the determined CSI-RS beam contains Doppler shift information. Further, the beamformed CSI-RS is sent to the terminal through the determined CSI-RS beam.

In some embodiments, sending the beamformed CSI-RS to the terminal includes: the beamformed CSI-RS is sent to the terminal through P CSI-RS ports.

For example, P is 16, and different beamformed CSI-RSs are sent to the terminal by the network device through the 16 CSI-RS ports.

In some embodiments, sending the beamformed CSI-RS to the terminal through the P CSI-RS ports includes: the beamformed CSI-RS is sent to the terminal at a plurality of consecutive moments through the P CSI-RS ports, where the CSI-RS beam of the same CSI-RS port at the plurality of moments uses the same spatial domain basis vector and the same frequency domain basis vector, and the CSI-RS beam of the same CSI-RS port at different moments uses different phase shifts.

S24: CSI reported by the terminal 102 is received.

In the embodiment of the present disclosure, the beamformed CSI-RS is sent to the terminal by the network device through the CSI-RS beam, the CSI is determined by the terminal after the terminal receives the beamformed CSI-RS sent by the network device, and further, the determined CSI may be reported to the network device.

In some embodiments, the CSI includes at least one of the following:
port selection indication information;
combination coefficient information;
frequency domain basis vector indication information; or
time domain basis vector indication information.

In the embodiment of the present disclosure, after receiving the beamformed CSI-RS sent by the network device, the terminal may perform a downlink channel estimation to obtain downlink effective channel information, the CSI is determined by using the estimated downlink effective channel information, then the determined CSI may be reported to the network device by the terminal, and one or more of the port selection indication information, the combination coefficient information, the frequency domain basis vector indication information and the time domain basis vector indication information are reported to the network device.

In an example, the terminal may select one or more target CSI-RS ports using the estimated downlink effective channel information, and then the terminal may report the port selection indication information to the network device to inform the network device of information of the target CSI-RS port selected by the terminal.

In an example, the terminal may select one or more frequency domain basis vectors using the estimated downlink effective channel information, and then the terminal may report the frequency domain basis vector indication information to the network device to inform the network device of information of the frequency domain basis vector selected by the terminal.

In an example, the terminal may select one or more time domain basis vectors using the estimated downlink effective channel information, and then the terminal may report the time domain basis vector indication information to the network device to inform the network device of information of the time domain basis vector selected by the terminal.

In an example, the terminal may select one or more combination coefficients using the estimated downlink effective channel information, and then the terminal may report the combination coefficient indication information to the network device to inform the network device of information of the combination coefficient selected by the terminal.

It should be understood that, the embodiments are not exhaustive and may be combined together for use. Further, the instances are schematic only and do not impose specific limitations on the embodiment of the present disclosure.

By the implementation of the embodiment of the present disclosure, the network device receives the uplink pilot signals sent by the terminal at the T consecutive moments, and performs the uplink channel estimation on the uplink pilot signals to determine the uplink channel information at each moment, where T is an integer greater than 1; the CSI-RS beam is determined according to the uplink channel information; the beamformed CSI-RS is sent to the terminal via the CSI-RS beam; and the CSI reported by the terminal is received. In this way, the demand of a terminal moving at medium to high speed for a shorter feedback period is met, and feedback overhead is reduced.

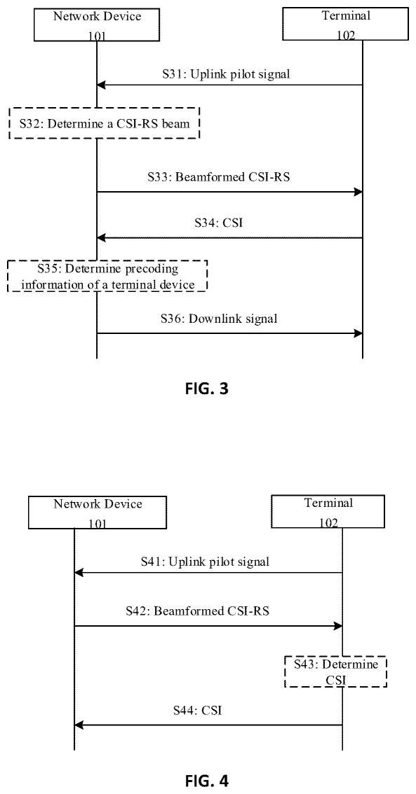

Referring to FIG. 3, FIG. 3 is a flowchart of a method for determining channel state information (CSI) according to an embodiment of the present disclosure.

As shown in FIG. 3, the method is performed by a network device 101 and may include, but is not limited to, the following steps S31-S26.

S31: uplink pilot signals sent by a terminal 102 at T consecutive moments are received, and an uplink channel estimation is performed on the uplink pilot signals to determine uplink channel information at each moment, where T is an integer greater than 1.

S32: a CSI-RS beam is determined according to the uplink channel information.

S33: the beamformed CSI-RS is sent to the terminal 102 through the CSI-RS beam.

S34: CSI reported by the terminal 102 is received.

Relevant descriptions of S31 to S34 may refer to the relevant descriptions in the instances, and the same descriptions will not be repeated here.

S35: precoding information of the terminal is determined according to the CSI.

The content of the CSI may refer to the relevant descriptions in the included embodiments, which will not be repeated here.

In some embodiments, precoding information W of the terminal is determined according to the CSI through one of the following formulas I-III.

$$W = \sqrt{a} {W}_{1} \qquad Formula I$$

$$W = \sqrt{b} {W}_{1} {W}_{f}^{H} . \qquad Formula II$$

$$W = \sqrt{c} {W}_{1} {( {W}_{d} ⊗ {W}_{f} )}^{H} . \qquad Formula III$$

Where \sqrt{a} is a power normalization factor, \sqrt{b} is a power normalization factor, \sqrt{c} is a power normalization factor, W₁ is port selection indication information, [symbol] is combination coefficient information, W_{f} is frequency domain basis vector indication information, W_{d} is time domain basis vector indication information, ⊗ denotes a Kronecker product operation of matrices, and A^{H} denotes conjugate transpose of a matrix A.

In some embodiments, the time domain basis vector indication information W_{d} is determined by the terminal according to the beamformed CSI-RS, or, the time domain basis vector indication information W_{d} is determined by selecting, by the terminal, from a time domain basis vector set configured by the network device.

It should be understood that, in the embodiment of the present disclosure, the time domain basis vector set is configured by the network device to the terminal, where the time domain basis vector set includes one or more time domain basis vectors, after receiving the time domain basis vector set configured by the network device, the terminal may select one or more time domain basis vectors from the time domain basis vector set, and then reports the CSI to the network device, the CSI includes the time domain basis vector indication information W_{d}, and the time domain basis vector indication information W_{d} includes the one or more time domain basis vectors selected by the terminal from the time domain basis vector set.

In some embodiments, the time domain basis vector set includes a plurality of consecutive time domain basis vectors or a plurality of inconsecutive time domain basis vectors.

In the embodiment of the present disclosure, the time domain basis vector set is configured by the network device to the terminal, and the time domain basis vector set includes a plurality of time domain basis vectors, where the plurality of time domain basis vectors may be a plurality of consecutive time domain basis vectors or a plurality of inconsecutive time domain basis vectors.

In the embodiment of the present disclosure, the network device receives the CSI reported by the terminal and determines the precoding information W of the terminal according to the CSI, and the network device receives the uplink pilot signals sent by the terminal at a plurality of consecutive moments. The number of samples of training signals for performing an uplink channel estimation is increased, the determined CSI-RS beam contains the Doppler shift information, the accurate precoding information W can be obtained, the demand of the terminal moving at a medium-high speed for a shorter feedback period is met, and feedback overhead is reduced.

In some embodiments, the precoding information W of the terminal is determined according to the CSI from a following formula: W=\sqrt{a}W₁ [symbol] .

The precoding information W at a moment t is determined from a following formula: W=W₁ (W₂⊙D′).

Where

$${D}^{′} = [ \begin{matrix}{e}^{j Δ t {φ}_{1}} \\ ⋮ \\ {e}^{j Δ t {φ}_{{K}_{1}}}\end{matrix} ] ,$$

Δt is a third time difference between a moment t and a moment at which the beamformed CSI-RS is first sent, φₚ is the phase shift corresponding to the p-th transmission path, K₁ is a first number of target CSI-RS ports selected by the terminal included in W₁, and p and K₁ are both positive integers.

In the embodiment of the present disclosure, the network device receives the CSI reported by the terminal and determines the precoding information W of the terminal according to the CSI, and the network device receives the uplink pilot signals sent by the terminal at a plurality of consecutive moments. The number of samples of training signals for performing an uplink channel estimation is increased, the determined CSI-RS beam contains the Doppler shift information, the accurate precoding information W can be obtained, the demand of the terminal moving at a medium-high speed for a shorter feedback period is met, and feedback overhead is reduced.

In some embodiments, the precoding information W of the terminal is determined according to the CSI from a following formula: W=\sqrt{b}W, [symbol] W_{f}^{H}.

The precoding information W at a moment t is determined from a following formula: W=(W₁ ⊙D″) [symbol] W_{f}^{H}.

Where

$${D}^{″} = [ \begin{matrix}{e}^{j Δ {t}^{″} {φ}_{1 , 1}} & … & {e}^{j Δ {t}^{″} {φ}_{1 , 2 L}} \\ ⋮ & ⋱ & ⋮ \\ {e}^{j Δ {t}^{″} {φ}_{{K}_{1} , 1}} & … & {e}^{j Δ {t}^{″} {φ}_{{K}_{1} , 2 L}}\end{matrix} ] ,$$

Δt′ is a fourth time difference between a moment t and a moment at which the beamformed CSI-RS is first sent, φₚ is the phase shift corresponding to the p-th transmission path, K₁ is a second number of target CSI-RS ports selected by the terminal included in W₁, L is a third number of unit basis vectors in one polarization direction, and p, L and K₁ are all positive integers.

In some embodiments, L and/or K₁ is determined by being configured by the network device, or determined by the terminal via reporting, or determined by being predefined by the terminal and the network device.

In the embodiment of the present disclosure, L may be determined by being configured by the network device, or determined by the terminal reporting to the network device, or determined by being predefined by the terminal and the network device.

In the embodiment of the present disclosure, K₁ may be determined by being configured by the network device, or determined by the terminal reporting to the network device, or determined by being predefined by the terminal and the network device.

In the embodiment of the present disclosure, the network device receives the CSI reported by the terminal and determines the precoding information W of the terminal according to the CSI, and the network device receives the uplink pilot signals sent by the terminal at a plurality of consecutive moments. In this way, the number of samples of training signals for performing the uplink channel estimation is increased. Since the determined CSI-RS beam contains the Doppler shift information, the accurate precoding information W can be obtained, the demand of the terminal moving at a medium-high speed for a shorter feedback period is met, and feedback overhead is reduced.

In some embodiments, the precoding information W of the terminal is determined according to the CSI from a following formula: W=\sqrt{c}W₁ [symbol] (W_{d}⊗W_{f})^{H}.

The precoding information W at a moment t is determined from a following formula: W=W₁ [symbol] (Wₜ_{_{d}}⊗W_{f})^{H}.

Where Wₜ_{_{d}}=[t_{d}_{₁}, . . . , t_{d}_{ᵥ}]∈ [symbol] , and let t_{d}_{ᵥ}=[1, . . . , e^{j2πvq}, . . . , e^{j2πv(Q-1)}]^{T}⊗f_{d,v}, f_{d,v} denotes the v-th target time domain basis vector of W_{d}, v ∈{1, . . . , V}, q∈{0, . . . , Q-1}, and T, V and Q are all positive integers.

In some embodiments, at least one of L, T, V and Q is determined by being configured by the network device, or determined by being reported by the terminal, or determined by being predefined by the terminal and the network device.

In the embodiment of the present disclosure, L may be determined by being configured by the network device, or determined by the terminal reporting to the network device, or determined by being predefined by the terminal and the network device.

In the embodiment of the present disclosure, T may be determined by being configured by the network device, or determined by the terminal reporting to the network device, or determined by being predefined by the terminal and the network device.

In the embodiment of the present disclosure, at least one of V may be determined by being configured by the network device, or determined by the terminal reporting to the network device, or determined by being predefined by the terminal and the network device.

In the embodiment of the present disclosure, at least one of Q may be determined by being configured by the network device, or determined by the terminal reporting to the network device, or determined by being predefined by the terminal and the network device.

It should be understood that, the embodiments are not exhaustive and may be combined together for use. Further, the instances are schematic only and do not impose specific limitations on the embodiment of the present disclosure.

In some embodiments, the time domain basis vector indication information Wa is determined by the terminal according to the beamformed CSI-RS; or the time domain basis vector indication information W_{d} is determined by selecting, by the terminal, from a time domain basis vector set configured by the network device.

It should be understood that, in the embodiment of the present disclosure, the time domain basis vector set is configured by the network device to the terminal, where the time domain basis vector set includes one or more time domain basis vectors, after receiving the time domain basis vector set configured by the network device, the terminal may select one or more time domain basis vectors from the time domain basis vector set, and then reports the CSI to the network device, the CSI includes the time domain basis vector indication information Wa, and the time domain basis vector indication information Wa includes the one or more time domain basis vectors selected by the terminal from the time domain basis vector set.

In some embodiments, the time domain basis vector set includes a plurality of consecutive time domain basis vectors or a plurality of inconsecutive time domain basis vectors.

In the embodiment of the present disclosure, the time domain basis vector set is configured by the network device to the terminal, and the time domain basis vector set includes a plurality of time domain basis vectors, where the plurality of time domain basis vectors may be a plurality of consecutive time domain basis vectors or a plurality of inconsecutive time domain basis vectors.

S36: a downlink signal is sent to the terminal according to the precoding information.

In the embodiment of the present disclosure, after determining the precoding information W of the terminal, the network device may send the downlink signal to the terminal according to the precoding information.

For the convenience of understanding, an example is provided according to the embodiment of the present disclosure below.

In an example, two SRSs are sent to a network device by a terminal at T=2, i.e., two consecutive slots, the SRSs sent at the two slots use the same SRS resource containing one SRS symbol. The repeated transmission of the two SRSs may also be defined as one SRS burst or time-domain bundling sending of SRS.

After receiving the SRSs sent by the terminal, the network device estimates uplink channel information corresponding to the two slots according to the received SRSs and calculates angle information SD basis Sᵢ, delay information FD basis fₙ and Doppler shift information φₖ of each transmission path.

Afterwards, a CSI-RS beam w=e^{j7φk}fₙ ⊗s; of the p-th transmission path at the t₀=8, i.e., the eighth slot, is determined by the network device according to the angle information SD basis Sᵢ, the delay information FD basis fₙ and the Doppler shift information φₖ of each transmission path, where Δt′=7, indicating that a first time difference between the eighth slot and a first moment (i.e., the first slot) at which the SRS is first received is 7 slots.

Then, different beamformed CSI-RSs are sent to the terminal at the moment to by the network device through P=16 CSI-RS ports. After receiving the CSI-RSs sent by the network device, the terminal estimates downlink effective channel information corresponding to each CSI-RS port, and selects a target CSI-RS port according to the effective channel information corresponding to each CSI-RS port and calculates a combination coefficient [symbol] of the selected target CSI-RS port. In a case where the number of target CSI-RS ports for selection configured by the network device for the terminal is 8, and the terminal may select 8 target CSI-RS ports from the 16 CSI-RS ports for sending the beamformed CSI-RSs of the network device, to generate port indication information and combination coefficient information and report the information to the network device.

Precoding information W of the terminal is calculated from W=\sqrt{a}W₁ [symbol] by the network device according to the port indication information and the combination coefficient information reported by the terminal. A calculation formula for the precoding information W at a future moment t is W=W₁ (W₂⊙D′), where

$${D}^{′} = [ \begin{matrix}{e}^{j Δ t {φ}_{1}} \\ ⋮ \\ {e}^{j Δ t {φ}_{{K}_{1}}}\end{matrix} ] ,$$

Δt is a third time difference between a moment t and a moment at which the beamformed CSI-RS is first sent, φₚ is phase shift corresponding to the p-th transmission path, K₁ is a first number of target CSI-RS ports included in W₁, and p and K₁ are both positive integers. A downlink signal may be sent to the terminal by the network device according to the precoding information.

For the convenience of understanding, another example is provided according to the embodiment of the present disclosure below.

In the embodiment, a terminal sends an SRS resource containing two SRS symbols repeatedly to a network device at T=4 consecutive slots. The network device estimates uplink channel information corresponding to the 4 slots according to the received SRS, and calculates SD basis si, FD basis fₙ and TD basis dₖ respectively corresponding to angle information, delay information and Doppler shift information of each transmission path of an uplink channel.

The network device determines that a beamformed CSI-RS burst is sent at the t₀=10th slot according to the angle information SD basis sᵢ, the delay information FD basis fₙ and the Doppler shift information φₖ of each transmission path, the network device determines a CSI-RS beam configured to transmit a beamformed CSI-RS according to the number of times the CSI-RS is transmitted within one CSI-RS burst, and the TD basis d′ is calculated through dₖ and a relative time difference between transmission of the CSI-RS and the SRS. One beamformed CSI-RS burst is defined as sending the beamformed CSI-RS at T′ consecutive moments, the CSI-RS beam of the p-th transmission path is w=d′ₖ (t′) fₙ ⊗sᵢ, t′∈{1, 2, . . . , T′}, and d′ₖ (t′) denotes the t′-th element in d′ₖ. For the same CSI-RS beam, sᵢ and fₙ are kept unchanged within one CSI-RS burst.

The network device starts to send one beamformed CSI-RS burst to the terminal at a moment to through P=16 CSI-RS ports, the terminal estimates downlink effective channel information corresponding to each CSI-RS port through the received CSI-RS burst, selects target CSI-RS ports according to the effective channel information corresponding to these CSI-RS ports at different moments, calculates a combination coefficient [symbol] of these target CSI-RS ports, and selects FD basis and TD basis from an FD basis set and a TD basis set configured by the network device, and desired FD basis and/or TD basis are reported to the network device by the terminal. In a case where the number of the target CSI-RS ports for selection configured by the network device for the terminal is 8, and the terminal reports indication information of the 8 target CSI-RS ports selected from the 16 ports, quantified combination coefficient information, frequency domain basis vector information and time domain basis vector information to the network device.

Precoding information of the terminal is calculated from W=\sqrt{c}W₁ [symbol] (W_{d}⊗W_{f})^{H} by the network device according to the port indication information, the quantified combination coefficient information, the frequency domain basis vector information and the time domain basis vector information reported by the terminal. A calculation formula for precoding at a future moment t is W=W₁ [symbol] (Wₜ_{_{d}} ⊗W_{f})^{H}, where Wₜ_{_{d}}=[t_{d}_{₁}, . . . , t_{d}_{ᵥ}]∈ [symbol] , and let t_{d}_{ᵥ}=[1, . . . , e^{j2πvq}, . . . , e^{j2πV(Q-1)}]^{T}⊗f_{d,v}, f_{d,v} denotes the v-th target time domain basis vector of W_{d}, v∈{1, . . . , V}, q∈{0, . . . , Q-1}, and T, V and Q are all positive integers. A downlink signal may be sent to the terminal by the network device according to the precoding information.

Referring to FIG. 4, FIG. 4 is a flowchart of a method for determining CSI according to an embodiment of the present disclosure.

As shown in FIG. 4, the method is performed by a terminal 102 and may include, but is not limited to, steps S41-S44 as follows.

S41: uplink pilot signals are sent to a network device 101 at T consecutive moments, where T is an integer greater than 1.

In the embodiment of the present disclosure, the terminal may send the uplink pilot signals on a plurality of consecutive moments. After receiving the uplink pilot signals sent by the terminal at the plurality of consecutive moments, the network device performs an uplink channel estimation on the uplink pilot signals to determine uplink channel information at each moment.

The uplink pilot signals may be sounding reference signals (SRSs).

In some embodiments, the terminal sending the uplink pilot signals to the network device includes at least one of the following: sending the uplink pilot signals at the same bandwidth and in the same frequency domain position; sending the uplink pilot signals at the same bandwidth and in different frequency domain positions; sending the uplink pilot signals at different bandwidths and in the same frequency domain position; or sending the uplink pilot signals at different bandwidths and in different frequency domain positions.

In an example, the terminal sends the uplink pilot signals to the network device at the same bandwidth and in the same frequency domain position.

In an embodiment, the terminal sends the uplink pilot signals to the network device at different bandwidths and in the same frequency domain position.

In an embodiment, the terminal sends the uplink pilot signals to the network device at the same bandwidth and in different frequency domain positions.

In an embodiment, the terminal sends the uplink pilot signals to the network device at different bandwidths and in different frequency domain positions.

It should be understood that, the embodiments are not exhaustive and may be combined together for use. Further, the instances are schematic only and do not impose specific limitations on the embodiment of the present disclosure.

S42: a beamformed CSI-RS sent by the network device is received, where a CSI-RS beam for sending the beamformed CSI-RS of the network device is determined by the network device according to the uplink channel information, and the uplink channel information is determined by performing the uplink channel estimation on the uplink pilot signals by the network device.

In the embodiment of the present disclosure, the terminal receives the beamformed CSI-RS sent on the CSI-RS beam by the network device, where the CSI-RS beam is determined by the network device according to the uplink channel information, and the uplink channel information is determined by performing the uplink channel estimation on the uplink pilot signals by the network device.

The content of the uplink channel information may refer to the relevant descriptions in the embodiments, which will not be repeated here.

In the embodiment of the present disclosure, after receiving the uplink pilot signals sent by the terminal at the plurality of consecutive moments, the network device performs the uplink channel estimation on the uplink pilot signals to determine the uplink channel information at each moment, and determine angle information, delay information and Doppler shift information.

The angle information may be denoted by a spatial domain basis vector, the delay information may be denoted by a frequency domain basis vector, and the Doppler shift information may be denoted by phase shift or a time domain basis vector.

Further, a CSI-RS beam at each moment is determined by the network device according to the spatial domain basis vector, the frequency domain basis vector and the phase shift.

In the embodiment of the present disclosure, the CSI-RS beam is determined by the network device according to the spatial domain basis vector, the frequency domain basis vector and the phase shift, the determined CSI-RS beam contains Doppler shift information, allowing for accurate precoding information to be obtained in the subsequent process, thereby meeting the demand of a terminal moving at medium to high speed for a shorter feedback period, and reducing feedback overhead.

In some embodiments, a CSI-RS beam w of the p-th transmission path at a moment to is determined from the following formula: w=e^{jΔt′φ}^{ₖ}fₙ⊗Sᵢ.

Where sᵢ is the i-th spatial domain basis vector corresponding to the p-th transmission path, fₙ is the n-th frequency domain basis vector corresponding to the p-th transmission path, Ok is the phase shift corresponding to the p-th transmission path, and p, i, n and k are all positive integers; and Δt′ denotes a first time difference between the moment t₀ and a first moment at which the uplink pilot signal is first received, and the first time difference is an integer multiple of a time difference between moments at which two adjacent uplink pilot signals are received.

It should be understood that, in the embodiment of the present disclosure, the CSI-RS beam w contains phase shift information, allowing for accurate precoding information to be obtained in the subsequent process, thereby meeting the demand of a terminal moving at medium to high speed for a shorter feedback period, and reducing feedback overhead.

In some embodiments, the first moment is an orthogonal frequency division multiplexing (OFDM) symbol position at which the uplink pilot signal is received at the first time before the network device sends the beamformed CSI-RS; and the time difference between the moments at which two adjacent uplink pilot signals are received is an OFDM symbol difference between OFDM symbol positions at which the two adjacent uplink pilot signals are received. Or the first moment is a slot position at which the uplink pilot signal is received at the first time before the network device sends the beamformed CSI-RS; and the time difference between the moments at which the two adjacent uplink pilot signals are received is a slot difference between slot positions at which the two adjacent uplink pilot signals are received.

For example, the OFDM symbol position at which the uplink pilot signal is received at the first time before the network device sends the beamformed CSI-RS is the first OFDM symbol, and in a case where the moment to is the eighth OFDM symbol, in this case, Δt′=7, indicating that a first time difference between the eighth OFDM symbol and the first OFDM symbol is 7 OFDM symbols.

For example, the slot position at which the uplink pilot signal is received at the first time before the network device sends the beamformed CSI-RS is the first slot, and in a case where the moment to is the eighth slot, in this case, Δt′=7, indicating that a first time difference between the eighth slot and the first slot is 7 slots.

In the embodiment of the present disclosure, the CSI-RS beam is determined by the network device according to the spatial domain basis vector, the frequency domain basis vector and the phase shift, the determined CSI-RS beam contains Doppler shift information, and further, the beamformed CSI-RS is sent to the terminal through the determined CSI-RS beam.

In some embodiments, sending the beamformed CSI-RS to the terminal includes: the beamformed CSI-RS is sent to the terminal through P CSI-RS ports.

For example, P is 16, and different beamformed CSI-RSs are sent to the terminal by the network device through the 16 CSI-RS ports.

In some embodiments, sending the beamformed CSI-RS to the terminal through the P CSI-RS ports includes: the beamformed CSI-RS is sent to the terminal at a plurality of consecutive moments through the P CSI-RS ports, where the CSI-RS beam of the same CSI-RS port at the plurality of moments uses the same spatial domain basis vector and the same frequency domain basis vector, and the CSI-RS beam of the same CSI-RS port at different moments uses different phase shifts.

S43: CSI is determined according to the beamformed CSI-RS.

S44: the CSI is sent to the network device.

In the embodiment of the present disclosure, the beamformed CSI-RS is sent to the terminal by the network device through the CSI-RS beam, the CSI is determined by the terminal after the terminal receives the beamformed CSI-RS sent by the network device, and further, the determined CSI may be reported to the network device.

In some embodiments, the CSI includes at least one of the following: port selection indication information; combination coefficient information; frequency domain basis vector indication information; or time domain basis vector indication information.

In the embodiment of the present disclosure, after receiving the beamformed CSI-RS sent by the network device, the terminal may perform a downlink channel estimation to obtain downlink effective channel information, the CSI is determined by using the estimated downlink effective channel information, then the determined CSI may be reported to the network device by the terminal, and one or more of the port selection indication information, the combination coefficient information, the frequency domain basis vector indication information and the time domain basis vector indication information are reported to the network device.

In an example, the terminal may select one or more target CSI-RS ports using the estimated downlink effective channel information, and then the terminal may report the port selection indication information to the network device to inform the network device of information of the target CSI-RS port selected by the terminal.

In an example, the terminal may select one or more frequency domain basis vectors using the estimated downlink effective channel information, and then the terminal may report the frequency domain basis vector indication information to the network device to inform the network device of information of the frequency domain basis vector selected by the terminal.

In an embodiment, the terminal may select one or more time domain basis vectors using the estimated downlink effective channel information, and then the terminal may report the time domain basis vector indication information to the network device to inform the network device of information of the time domain basis vector selected by the terminal.

In an example, the terminal may select one or more combination coefficients using the estimated downlink effective channel information, and then the terminal may report the combination coefficient information to the network device to inform the network device of information of the combination coefficient selected by the terminal.

It should be understood that, the embodiments are not exhaustive and may be combined together for use. Further, the instances are schematic only and do not impose specific limitations on the embodiment of the present disclosure.

In some embodiments, the port selection indication information is configured to indicate target CSI-RS ports selected by the terminal, where the number of the target CSI-RS ports is determined by being configured by the network device, or determined by the terminal according to downlink channel information, or determined by being predefined by the terminal and the network device.

In some embodiments, the port selection indication information is configured to indicate the target CSI-RS port(s).

In a case where there are two polarization directions, the same target CSI-RS port is selected for different polarization directions. Alternatively, different target CSI-RS ports are selected for different polarization directions.

In a case where there are a plurality of transmission layers, the same target CSI-RS port is selected for different transmission layers. Alternatively, different target CSI-RS ports are selected for different transmission layers.

In some embodiments, the combination coefficient information includes non-zero coefficients and/or non-zero coefficient positions, where a maximum value of the number of the non-zero coefficients is determined by being configured by the network device, or determined by the terminal according to the downlink channel information, or determined by being predefined by the terminal and the network device.

In some embodiments, the T moments correspond to T uplink pilot signal symbols, or, the T moments correspond to T slots at which the uplink pilot signals are sent.

In some embodiments, the uplink pilot signals sent on different OFDM symbols within one slot or the T slots are the same or different.

In some embodiments, the frequency domain basis vector indication information includes target frequency domain basis vector(s).

In a case where there are two polarization directions, the same target frequency domain basis vector is selected for different polarization directions. Alternatively, different target frequency domain basis vectors are selected for different polarization directions.

In a case where there are a plurality of transmission layers, the same or different target frequency domain basis vectors are selected for different transmission layers.

In some embodiments, the time domain basis vector indication information includes target time domain basis vector(s).

In a case where there are two polarization directions, the same or different target time domain basis vectors are selected for different polarization directions.

In a case where there are a plurality of transmission layers, the same or different target time domain basis vectors are selected for different transmission layers.

In some embodiments, the time domain basis vector indication information includes one or more target time domain basis vectors.

The target time domain basis vector is denoted by at least one of the following forms: a discrete Fourier transform (DFT) basis vector; a discrete cosine transform (DCT) basis vector; or a polynomial coefficient.

In the embodiment of the present disclosure, for the DFT basis vector or the discrete cosine DCT basis vector, a parameter O3 may be introduced to perform oversampling expansion on the basis vectors to obtain more basis vector information.

By the implementation of the embodiment of the present disclosure, the uplink pilot signals are sent to the network device by the terminal at the T consecutive moments, where T is an integer greater than 1; the beamformed CSI-RS sent on the CSI-RS beam by the network device is received, where the CSI-RS beam is determined by the network device according to the uplink channel information, and the uplink channel information is determined by performing the uplink channel estimation on the uplink pilot signals by the network device; the CSI is determined according to the beamformed CSI-RS; and the CSI is sent to the network device. In this way, the demand of the terminal moving at a medium to high speed for shorter feedback period is met, and the feedback overhead is reduced.

In the embodiments provided by the present disclosure, the methods provided in the embodiments of the present disclosure are introduced from the perspectives of the network device and the terminal respectively. In order to achieve the functions in the methods provided in the embodiments of the present disclosure, the network device and the terminal may include a hardware structure and a software module to achieve the functions in the form of the hardware structure, the software module, or the hardware structure plus the software module. One of the functions may be performed in the form of the hardware structure, the software module or the hardware structure plus the software module.

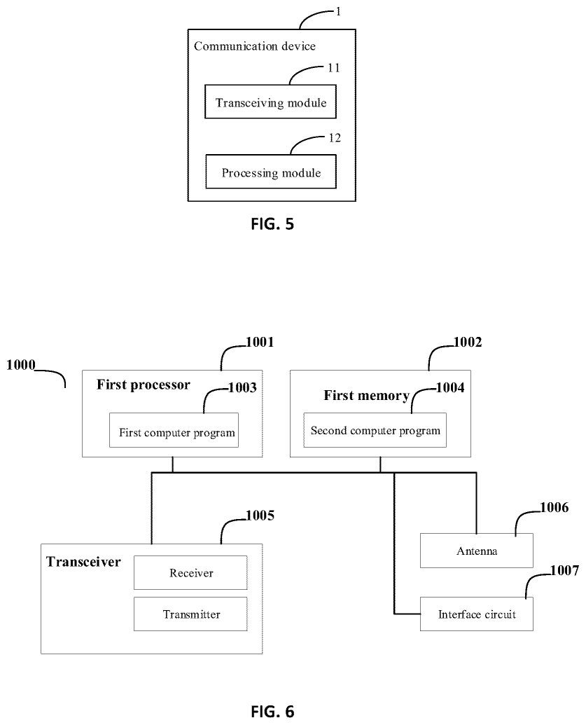

Referring to FIG. 5, FIG. 5 is a structural diagram of a communication device 1 according to an embodiment of the present disclosure. The communication device 1 shown in FIG. 5 may include a transceiving module 11 and a processing module 12. The transceiving module 11 may include a sending module and/or a receiving module, the sending module is configured to implement a sending function, the receiving module is configured to implement a receiving function, and the transceiving module 11 may implement the sending function and/or the receiving function.

The communication device 1 may be a terminal or a device in the terminal, or a device that can be used in conjunction with the terminal. Alternatively, the communication device 1 may be a network device or a device in the network device, or a device that can be used in conjunction with the network device.

In a case where the communication device 1 is the network device, the transceiving module 11 is configured to receive uplink pilot signals sent by the terminal at T consecutive moments, and perform an uplink channel estimation on the uplink pilot signals to determine uplink channel information at each moment, where T is an integer greater than 1.

The processing module 12 may be a processor, CPU, or the like and is configured to determine a CSI-RS beam according to the uplink channel information.

The transceiving module 11 is further configured to send a beamformed CSI-RS to the terminal according to the CSI-RS beam.

The transceiving module 11 is further configured to receive CSI reported by the terminal.

In some embodiments, the processing module 12 is further configured to determine precoding information of the terminal according to the CSI.

The transceiving module 11 is further configured to send a downlink signal to the terminal according to the precoding information.

In some embodiments, the uplink channel information includes angle information, delay information and Doppler shift information, the angle information is denoted by a spatial domain basis vector, the delay information is denoted by a frequency domain basis vector, and the Doppler shift information is denoted by phase shift or a time domain basis vector.

In some embodiments, the processing module 12 is configured to determine a CSI-RS beam at each moment according to the spatial domain basis vector, the frequency domain basis vector and target phase shift, where the target phase shift is the phase shift or is determined according to the time domain basis vector.

A CSI-RS beam w of the p-th transmission path at a moment to is determined from the following formula: w=e^{jΔt′φ}^{ₖ}fₙ ⊗sᵢ.

Where sᵢ is the i-th spatial domain basis vector corresponding to the p-th transmission path, fₙ is the n-th frequency domain basis vector corresponding to the p-th transmission path, Ok is the phase shift corresponding to the p-th transmission path, and p, i, n and k are all positive integers; and Δt′ denotes a first time difference between the moment t₀ and a first moment at which the uplink pilot signals is first received, and the first time difference is an integer multiple of a time difference between moments at which two adjacent uplink pilot signals are received.

In some embodiments, the first moment is an OFDM symbol position at which the uplink pilot signal is received at the first time before the network device sends the beamformed CSI-RS, and the time difference between the moments at which the two adjacent uplink pilot signals are received is an OFDM symbol difference between OFDM symbol positions at which the two adjacent uplink pilot signals are received; or the first moment is a slot position at which the uplink pilot signal is received at the first time before the network device sends the beamformed CSI-RS, and the time difference between the moments at which the two adjacent uplink pilot signals are received is a slot difference between slot positions at which the two adjacent uplink pilot signals are received.

In some embodiments, the transceiving module 11 is further configured to send the beamformed CSI-RS to the terminal through P CSI-RS ports.

The transceiving module 11 is further configured to send the beamformed CSI-RS to the terminal at a plurality of consecutive moments through the P CSI-RS ports, where the CSI-RS beam of the same CSI-RS port at the plurality of moments uses the same spatial domain basis vector and the same frequency domain basis vector, and the CSI-RS beam of the same CSI-RS port at different moments uses different phase shift.

In some embodiments, the CSI includes at least one of the following: port selection indication information; combination coefficient information; frequency domain basis vector indication information; or time domain basis vector indication information.

In some embodiments, the processing module 12 is configured to determine precoding information of the terminal according to the CSI, including determining precoding information W from one of the following formulas, I-III.

$$W = \sqrt{a} {W}_{1} . \qquad Formula I$$

$$W = \sqrt{b} {W}_{1} {W}_{f}^{H} . \qquad Formula II$$

$$W = \sqrt{c} {W}_{1} {( {W}_{d} ⊗ {W}_{f} )}^{H} . \qquad Formula III$$

Where \sqrt{a} is a power normalization factor, \sqrt{b} is a power normalization factor, \sqrt{c} is a power normalization factor, W₁ is port selection indication information, [symbol] is combination coefficient information, W_{f} is frequency domain basis vector indication information, W_{d} is time domain basis vector indication information, ⊗ denotes a Kronecker product operation of matrices, and A^{H} denotes conjugate transpose of a matrix A.

In some embodiments, for Formula I: W=\sqrt{a}W₁ [symbol] , the precoding information W at a moment t is determined from a following formula: W=W₁ (W₂⊙D′).

Where

$${D}^{′} = [ \begin{matrix}{e}^{j Δ t {φ}_{1}} \\ ⋮ \\ {e}^{j Δ t {φ}_{{K}_{1}}}\end{matrix} ] ,$$

Δt is a third time difference between a moment t and a moment at which the beamformed CSI-RS is first sent, φₚ is the phase shift corresponding to the p-th transmission path, K₁ is a first number of target CSI-RS ports selected by the terminal included in W₁, and p and K₁ are both positive integers.

In some embodiments, for Formula II: W=\sqrt{b}W₁ [symbol] W_{f}^{H}, the precoding information W at a moment t is determined from a following formula: W=(W₁ ⊙D″) [symbol] W_{f}^{H}.

Where

$${D}^{″} = [ \begin{matrix}{e}^{j Δ {t}^{″} {φ}_{1 , 1}} & … & {e}^{j Δ {t}^{″} {φ}_{1 , 2 L}} \\ ⋮ & ⋱ & ⋮ \\ {e}^{j Δ {t}^{″} {φ}_{{K}_{1} , 1}} & … & {e}^{j Δ {t}^{″} {φ}_{{K}_{1} , 2 L}}\end{matrix} ] ,$$

Δt′ is a fourth time difference between a moment t and a moment at which the beamformed CSI-RS is first sent, φₚ is the phase shift corresponding to the p-th transmission path, K₁ is a second number of target CSI-RS ports selected by the terminal included in W₁, L is a third number of unit basis vectors in one polarization direction, and p, L and K₁ are all positive integers.

In some embodiments, for Formula III: W=\sqrt{c}W₁ [symbol] (W_{d}⊗W_{f})^{H}, the precoding information W at a moment t is determined from a following formula: W=W₁ [symbol] (Wₜ_{_{d}}⊗W_{f})^{H}.

Where Wₜ_{_{d}}=[t_{d}_{₁}, . . . , t_{d}_{ᵥ}]∈ [symbol] , and let t_{d}_{ᵥ}=[1, . . . , e^{j2πvq}, . . . , e^{j2πv(Q-1)}]^{T}⊗f_{d,v}, f_{d,v} denotes the v-th target time domain basis vector of W_{d}, v∈{1, . . . , V}, q∈{0, . . . , Q-1}, and T, V and Q are all positive integers.

In some embodiments, at least one of L, T, V and Q is determined by being configured by the network device, or determined by being reported by the terminal, or determined by being predefined by the terminal and the network device.

In some embodiments, the time domain basis vector indication information W_{d} is determined by the terminal according to the beamformed CSI-RS, or, the time domain basis vector indication information W_{d} is determined by selecting, by the terminal, from a time domain basis vector set configured by the network device.

In some embodiments, the time domain basis vector set includes a plurality of consecutive time domain basis vectors or a plurality of inconsecutive time domain basis vectors.

In a case where the communication device 1 is the terminal, the transceiving module 11 is configured to send uplink pilot signals to the network device at T consecutive moments, where T is an integer greater than 1.

The transceiving module 11 is further configured to receive a beamformed CSI-RS sent on a CSI-RS beam by the network device, where the CSI-RS beam for sending the beamformed CSI-RS of the network device is determined by the network device according to uplink channel information, and the uplink channel information is determined by performing an uplink channel estimation on the uplink pilot signals by the network device.

The processing module 12 is configured to determine CSI according to the beamformed CSI-RS.

The transceiving module 11 is further configured to send the CSI to the network device.

In some embodiments, the CSI includes at least one of the following: port selection indication information; combination coefficient information; frequency domain basis vector indication information; or time domain basis vector indication information.

In some embodiments, the port selection indication information is configured to indicate target CSI-RS ports selected by the terminal, where the number of the target CSI-RS ports is determined by being configured by the network device, or determined by the terminal according to downlink channel information, or determined by being predefined by the terminal and the network device.

In some embodiments, the combination coefficient information includes non-zero coefficients and/or non-zero coefficient positions, where a maximum value of the number of the non-zero coefficients is determined by being configured by the network device, or determined by the terminal according to the downlink channel information, or determined by being predefined by the terminal and the network device.

In some embodiments, the T moments correspond to T uplink pilot signal symbols, or, the T moments correspond to T slots at which the uplink pilot signals are sent.

In some embodiments, the uplink pilot signals sent on different OFDM symbols within one slot or the T slots are the same or different.

In some embodiments, the transceiving module 11 is further configured to send the uplink pilot signals to the network device, including at least one of the following: sending the uplink pilot signals at the same bandwidth and in the same frequency domain position; sending the uplink pilot signals at the same bandwidth and in different frequency domain positions; sending the uplink pilot signals at different bandwidths and in the same frequency domain position; or sending the uplink pilot signals at different bandwidths and in different frequency domain positions.

As for the communication device 1 in the embodiment, the specific manner in which each module performs operations has been described in detail in the embodiment of the method, which will not be described in detail here.

The communication device 1 provided in the embodiment of the present disclosure achieves the same or similar beneficial effects as the communication method provided in some of the embodiments, which will not be repeated here.

Referring to FIG. 6, FIG. 6 is a structural diagram of a communication device 1000 according to another embodiment of the present disclosure. The communication device 1000 may be a network device, a terminal, a chip, chip system or processor which support the network device to implement the methods or a chip, chip system or processor which support the terminal to implement the methods. The communication device 1000 may be configured to implement the method described in the method embodiments, which can refer to the description in the method embodiments specifically.

The communication device 1000 may be a network device, a terminal, a chip, chip system or processor which support the network device to implement the method, or a chip, chip system or processor which support the terminal to implement the methods. The device may be configured to implement the methods described in the method embodiments, which can refer to the description in the method embodiments specifically.

The communication device 1000 may include one or more first processors 1001. The first processor 1001 may be a general-purpose processor or a special-purpose processor, etc. For example, the processor may be a baseband processor or a central processor. The baseband processor may be configured to process a communication protocol and communication data, and the central processor may be configured to control the communication device (e.g., base station, baseband chip, terminal device, terminal device chip, DU or CU), execute computer programs and process data of computer programs.

Optionally, the communication device 1000 may further include one or more first memories 1002, on which a second computer program 1004 may be stored, and the first memory 1002 executes the second computer program 1004 to cause the communication device 1000 to execute the method described in the method embodiments. Optionally, data may further be stored in the first memory 1002. The communication device 1000 and the first memory 1002 may be arranged independently or integrated.

Optionally, the communication device 1000 may further include a transceiver 1005 and an antenna 1006. The transceiver 1005 may be referred to as a transceiving unit, a transceiving device, or a transceiving circuit, etc., which is configured to implement a transceiving function. The transceiver 1005 may include a receiver and a transmitter, the receiver may be referred to as a receiving device or a receiving circuit, etc., which is configured to implement a receiving function, and the transmitter is referred to as a transmitting/sending device or a transmitting/sending circuit, etc., which is configured to implement a transmitting/sending function.

Optionally, the communication device 1000 may further include one or more interface circuits 1007. The interface circuit 1007 is configured to receive and transmit code instructions to the first processor 1001. The first processor 1001 runs the code instructions to cause the communication device 1000 to execute the method described in the method embodiments.

In a case where the communication device 1000 is the network device, the transceiver 1005 is configured to execute S21, S23 and S24 in FIGS. 2, and S31, S33, S34 and S36 in FIG. 3, and the first processor 1001 is configured to execute S22 in FIGS. 2, and S32 and S35 in FIG. 3.

In a case where the communication device 1000 is the terminal: the transceiver 1005 is configured to execute S41, S42 and S44 in FIG. 4, and the first processor 1001 is configured to execute S43 in FIG. 4.

In an implementation, the first processor 1001 may include a transceiver configured to implement receiving and sending functions. For example, the transceiver may be a transceiving circuit, an interface, or an interface circuit. The transceiving circuit, the interface, or the interface circuit configured with the receiving and sending functions may be separated or integrated. The transceiving circuit, interface or interface circuit may be configured to read and write codes/data, or, the transceiving circuit, interface or interface circuit may be configured to transmit or transfer signals.

In an implementation, a first computer program 1003 may be stored in the first processor 1001, and by running on the first processor 1001, the first computer program 1003 may cause the communication device 1000 to perform the method described in the method embodiments. The first computer program 1003 may be solidified in the first processor 1001, in this case, the first processor 1001 may be implemented by hardware.

In an implementation, the communication device 1000 may include a circuit, and the circuit may implement the function of sending or receiving or communication in the aforementioned method embodiments. The processor and the transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and the transceiver may also be manufactured using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BICMOS), silicon germanium (SiGe) and gallium arsenide (GaAs).

The communication device described in the embodiment may be the terminal, but the scope of the communication device described in the present disclosure is not limited to this, and the structure of the communication device may not be limited by FIG. 6. The communication device may be an independent device or a part of a large device. For example, the communication device may be: (1) an independent integrated circuit IC, or a chip or a chip system or a sub-system; (2) a collection with one or more ICs, where optionally, the IC collection may also include a storage component for storing data and computer programs; (3) an ASIC, such as a modem; (4) a module capable of being embedded into other devices; (5) a receiver, a terminal, a smart terminal, a cellular phone, a wireless device, a handset, a mobile unit, a vehicle-mounted device, a network device, a cloud device, an artificial intelligence device, etc.; and (6) others.

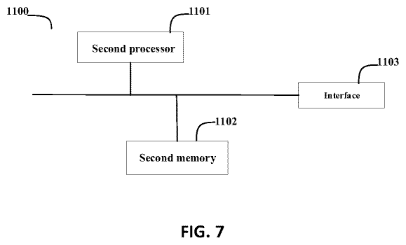

For the case that the communication device may be a chip or a chip system, see FIG. 7, FIG. 7 is a schematic structural diagram of a chip 1100 according to an embodiment of the present disclosure.

The chip 1100 includes a second processor 1101, a second memory 1102, and an interface 1103. There may be one or more second processors 1101, one or more second memories 1102, and a plurality of interfaces 1103.

For the case that the chip 1100 is configured to implement functions of a terminal in an embodiment of the present disclosure. The interface 1103 is configured to receive and transmit code instructions to the second processor 1101. The second processor 1101 is configured to run the code instructions to perform the method for determining channel state information (CSI) described as in some embodiments.

For the case that the chip is 1100 configured to implement functions of a network device in an embodiment of the present disclosure. The interface 1103 is configured to receive and transmit code instructions to the second processor 1101. The second processor 1101 is configured to run the code instructions to perform the method for determining channel state information (CSI) described as in some of the embodiments.

The second memory 1102 is configured to store necessary computer programs and data.

Those skilled in the art may further understand that various illustrative logic blocks and steps listed in the embodiments of the present disclosure may be implemented through electronic hardware, computer software and a combination of the two. Whether such functions are implemented through hardware or software depends on specific applications and the design requirements of an entire system. Those skilled in the art may use various methods to implement the functions for each specific application, but such implementation should not be considered to be beyond the scope of protection of the embodiments of the present disclosure.

A communication system is further provided according to an embodiment of the present disclosure. The communication system includes the communication device used as the terminal and the communication device used as the network device in the aforementioned embodiment in FIG. 5. Or the system includes the communication device used as the terminal and the communication device used as the network device in the aforementioned embodiment in FIG. 6.

A non-transitory computer-readable storage medium is further provided according to an embodiment of the present disclosure. The non-transitory computer-readable storage medium stores instructions, when executed by a computer, the instructions implement the functions of any method embodiments.

A computer program product is further provided according to an embodiment of the present disclosure, when executed by a computer, the computer program product implements the functions of any method embodiment.

The embodiments may be implemented entirely or partially through software, hardware, firmware or any combination of them. When software is used for implementation, implementation may be entirely or partially performed in the form of the computer program product. The computer program product includes one or more computer programs. When the computer program is loaded and executed on a computer, all or part of the flows or functions described according to the embodiments of the present disclosure are generated. The computer may be a general-purpose computer, a special-purpose computer, a computer network, or other programmable devices. The computer program may be stored in a computer-readable storage medium or transmitted from one computer-readable storage medium to another computer-readable storage medium. For example, the computer program may be transmitted from one website, computer, server or data center to another website, computer, server or data center in a wired (e.g., a coaxial cable, an optical fiber or a digital subscriber line (DSL)) or wireless (e.g., infrared, wireless or microwave) manner. The computer-readable storage medium may be any available medium capable of being accessed by a computer or include one or more data storage devices integrated by an available medium, such as a server and a data center. The available medium may be a magnetic medium (such as a floppy disk, a hard disk, or magnetic tape), an optical medium (such as a high-density digital video disc (DVD)), or a semiconductor medium (such as a solid state disk (SSD)) or the like.

Those of ordinary skill in the art may understand that: various numerical numbers involved in the present disclosure, such as first and second, are distinguished only for the convenience of description and are not intended to limit the scope of the embodiments of the present disclosure or indicate an order of priority.

At least one in the present disclosure may also be described as one or more, and “a plurality of” may be two, three, four, or more, without limitation in the present disclosure. In the embodiments of the present disclosure, for a technical feature, technical features in the technical feature are distinguished by “first”, “second”, “third”, “A”, “B”, “C”, and “D”, etc., and the technical features described by “first”, “second”, “third”, “A”, “B”, “C”, and “D” have no order of priority or size.

Correspondence relationships shown in each table in the present disclosure may be configured or predefined. Values of information in each table are only embodiments and may be configured as other values, which are not limited in the present disclosure. When the correspondence relationships between information and various parameters are configured, it is not necessarily required to configure all the correspondence relationships shown in each table. For example, in the tables in the present disclosure, the correspondence relationships shown in certain rows may not be configured. For another embodiment, appropriate transformation adjustments may be made based on the tables, such as splitting and merging. The names of parameters shown in titles in the tables may also be other names that a communication device can understand, and values or representations of the parameters may also be other values or representations that the communication device can understand. The tables may also be implemented using other data structures, such as arrays, queues, containers, stacks, linear tables, pointers, linked lists, trees, graphs, structures, classes, heaps, hashed lists or hash tables, etc.

Pre-definitions in the present disclosure may be understood as definitions, definitions in advance, storage, pre-storage, pre-negotiation, pre-configurations, solidification, or pre-firing.

A person of ordinary skill in the art may recognize that the exemplary units and algorithm steps described with reference to the embodiments disclosed herein can be implemented in electronic hardware, or a combination of computer software and electronic hardware. Whether the functions are executed in a mode of hardware or software depends on particular applications and design constraint conditions of the technical solutions. A person skilled in the art may use different methods to implement the described functions for each particular application, but it shall not be considered that the implementation goes beyond the scope of the present disclosure.

Those skilled in the art may clearly understand that, for the convenience of description and conciseness, specific working processes of the systems, devices and units described may refer to the corresponding processes in the aforementioned method embodiment, which will not be repeated here.

The descriptions are merely specific embodiments of the present disclosure, which do not limit the protection scope of the present disclosure. Any variations or substitutions that those skilled in the art can easily conceive within the technical scope disclosed in the present disclosure should be included within the protection scope of the present disclosure. Therefore, the protection scope of the present disclosure shall be defined by the scope of the claims below.

1. A method for determining channel state information (CSI), performed by a network device, wherein the method comprises:
receiving uplink pilot signals sent by a terminal at T consecutive moments;
performing uplink channel estimation on the uplink pilot signals to determine uplink channel information at each moment, wherein T is an integer greater than 1;
determining a channel state information reference signal (CSI-RS) beam according to the uplink channel information;
sending a beamformed CSI-RS to the terminal according to the CSI-RS beam; and
receiving CSI reported by the terminal.

2. The method according to claim 1, after receiving the CSI reported by the terminal, wherein the method further comprises:
determining precoding information of the terminal according to the CSI; and
sending a downlink signal to the terminal according to the precoding information.

3. The method according to claim 1, wherein
the uplink channel information comprises angle information, delay information and Doppler shift information,
the angle information is denoted by a spatial domain basis vector,
the delay information is denoted by a frequency domain basis vector, and
the Doppler shift information is denoted by phase shift or a time domain basis vector.

4. The method according to claim 3, wherein determining the CSI-RS beam according to the uplink channel information comprises:
determining the CSI-RS beam at each moment according to the spatial domain basis vector, the frequency domain basis vector and target phase shift, wherein the target phase shift is the phase shift or is determined according to the time domain basis vector;
wherein a CSI-RS beam w of a p-th transmission path at a moment to is determined from a formula:
w=e^{jΔt′φ}^{ₖ}fₙ⊗sᵢ;
wherein sᵢ is an i-th spatial domain basis vector corresponding to the p-th transmission path, fₙ is an n-th frequency domain basis vector corresponding to the p-th transmission path, Ok is the phase shift corresponding to the p-th transmission path, and p, i, n and k are all positive integers; and Δt′ denotes a first time difference between the moment to and a first moment at which the uplink pilot signal is first received, and the first time difference is an integer multiple of a time difference between moments at which two adjacent uplink pilot signals are received.

5. The method according to claim 4, wherein
the first moment is an orthogonal frequency division multiplexing (OFDM) symbol position at which the uplink pilot signal is received at a first time before the network device sends the beamformed CSI-RS, and the time difference between the moments at which the two adjacent uplink pilot signals are received is an OFDM symbol difference between OFDM symbol positions at which the two adjacent uplink pilot signals are received; or
the first moment is a slot position at which the uplink pilot signal is received at the first time before the network device sends the beamformed CSI-RS, and the time difference between the moments at which the two adjacent uplink pilot signals are received is a slot difference between slot positions at which the two adjacent uplink pilot signals are received.

6. The method according to claim 5, wherein sending the beamformed CSI-RS to the terminal comprises:
sending the beamformed CSI-RS to the terminal through P CSI-RS ports.

7. The method according to claim 6, wherein sending the beamformed CSI-RS to the terminal through the P CSI-RS ports comprises:
sending the beamformed CSI-RS to the terminal at a plurality of consecutive moments through the P CSI-RS ports, wherein the CSI-RS beam of a same CSI-RS port at the plurality of moments uses a same spatial domain basis vector and a same frequency domain basis vector, and the CSI-RS beam of the same CSI-RS port at different moments uses different phase shifts.

8. The method according to claim 3, wherein the CSI comprises at least one of:
port selection indication information;
combination coefficient information;
frequency domain basis vector indication information; or
time domain basis vector indication information.

9. The method according to claim 8, wherein determining the precoding information of the terminal according to the CSI comprises:
determining precoding information W from one of:
$$W = \sqrt{a} {W}_{1} ; \qquad Formula I$$
$$W = \sqrt{b} {W}_{1} {W}_{f}^{H} ; or \qquad Formula II$$
$$W = \sqrt{c} {W}_{1} {( {W}_{d} ⊗ {W}_{f} )}^{H} ; \qquad Formula III$$
wherein \sqrt{a} is a power normalization factor, \sqrt{b} is a power normalization factor, \sqrt{c} is a power normalization factor, W₁ is the port selection indication information, [symbol] is the combination coefficient information, W_{f} is the frequency domain basis vector indication information, W_{d} is the time domain basis vector indication information, ⊗ denotes a Kronecker product operation of matrices, and A^{H} denotes conjugate transpose of a matrix A.

10. The method according to claim 9, wherein, for Formula I:
W=\sqrt{a}w₁ [symbol] ,
the precoding information W at a moment t is determined from a formula:
W=W₁(W₂⊙D′);
wherein
$${D}^{′} = [ \begin{matrix}{e}^{j Δ t {φ}_{1}} \\ ⋮ \\ {e}^{j Δ t {φ}_{{K}_{1}}}\end{matrix} ] ,$$
Δt is a third time difference between the moment t and a moment at which the beamformed CSI-RS is first sent, φₚ is the phase shift corresponding to the p-th transmission path, K₁ is a first number of target CSI-RS ports selected by the terminal comprised in W₁, and p and K₁ are both positive integers.

11. The method according to claim 9, wherein, for Formula II:
W=\sqrt{b}W₁ [symbol] W_{f}H,
the precoding information W at a moment t is determined from a formula:
W=(W₁⊙D″) [symbol] W_{f}^{H};
wherein
$${D}^{″} = [ \begin{matrix}{e}^{j Δ {t}^{″} {φ}_{1 , 1}} & … & {e}^{j Δ {t}^{″} {φ}_{1 , 2 L}} \\ ⋮ & ⋱ & ⋮ \\ {e}^{j Δ {t}^{″} {φ}_{{K}_{1} , 1}} & … & {e}^{j Δ {t}^{″} {φ}_{{K}_{1} , 2 L}}\end{matrix} ] ,$$
Δt′ is a fourth time difference between the moment t and a moment at which the beamformed CSI-RS is first sent, φₚ is the phase shift corresponding to the p-th transmission path, K₁ is a second number of target CSI-RS ports selected by the terminal comprised in W₁, L is a third number of unit basis vectors in one polarization direction, and p, L and K₁ are all positive integers.

12. The method according to claim 9, wherein, for Formula III: W=\sqrt{c}W₁ [symbol] (W_{d}⊗W_{f})^{H},
the precoding information W at a moment t is determined from a formula:
W=W₁ [symbol] (Wₜ_{_{d}}⊗W_{f})^{H};
wherein Wₜ_{_{d}}=[t_{d}_{₁}, . . . , t_{d}_{ᵥ}]∈ [symbol] , and let t_{d}_{ᵥ}=[1, . . . , e^{j2πvq}, . . . , e^{j2πv(Q-1)}]^{T}⊗f_{d,v}, f_{d,v} denotes the v-th target time domain basis vector of W_{d}, v∈{1, . . . , V}, q∈{0, . . . , Q-1}, and T, V and Q are all positive integers.

13. (canceled)

14. The method according to claim 9, wherein the time domain basis vector indication information W_{d} is determined by the terminal according to the CSI-RS; or the time domain basis vector indication information W_{d} is determined by selecting, by the terminal, from a time domain basis vector set configured by the network device.

15. (canceled)

16. A method for determining channel state information (CSI), performed by a terminal, wherein the method comprises:
sending uplink pilot signals to a network device at T consecutive moments, wherein T is an integer greater than 1;
receiving a beamformed CSI-RS sent by the network device, wherein a CSI-RS beam for sending the beamformed CSI-RS of the network device is determined by the network device according to uplink channel information, and the uplink channel information is determined by performing an uplink channel estimation on the uplink pilot signals by the network device;
determining CSI according to the beamformed CSI-RS; and
sending the CSI to the network device.

17. The method according to claim 16, wherein the CSI comprises at least one of:
port selection indication information;
combination coefficient information;
frequency domain basis vector indication information; or
time domain basis vector indication information.

18. The method according to claim 17,
wherein the port selection indication information is configured to indicate target CSI-RS ports selected by the terminal, wherein a number of the target CSI-RS ports is determined by being configured by the network device, or determined by the terminal according to downlink channel information, or determined by being predefined by the terminal and the network device; or
wherein the combination coefficient information comprises non-zero coefficients and/or non-zero coefficient positions, wherein a maximum value of a number of the non-zero coefficients is determined by being configured by the network device, or determined by the terminal according to downlink channel information, or determined by being predefined by the terminal and the network device.

19. (canceled)

20. The method according to claim 16, wherein the T moments correspond to T uplink pilot signal symbols; or the T moments correspond to T slots at which the uplink pilot signals are sent; wherein the uplink pilot signals sent on different OFDM symbols within one slot or the T slots are a same or different.

21. (canceled)

22. The method according to claim 16, wherein sending the uplink pilot signals to the network device comprises at least one of:
sending the uplink pilot signals at a same bandwidth and in a same frequency domain position;
sending the uplink pilot signals at the same bandwidth and in different frequency domain positions;
sending the uplink pilot signals at different bandwidths and in the same frequency domain position; or
sending the uplink pilot signals at different bandwidths and in different frequency domain positions.

23-24. (canceled)

25. A network device, comprising:
one or more processors; and
a memory that stores a computer program, wherein
the one or more processors executes the computer program stored in the memory to cause the network device to receive uplink pilot signals sent by a terminal at T consecutive moments; perform uplink channel estimation on the uplink pilot signals to determine uplink channel information at each moment, wherein T is an integer greater than 1; determine a channel state information reference signal (CSI-RS) beam according to the uplink channel information; send a beamformed CSI-RS to the terminal according to the CSI-RS beam; and receive CSI reported by the terminal.

26-27. (canceled)

28. A terminal, comprising:
one or more processors; and
a memory that stores a computer program, wherein the one or more processors execute the computer program stored in the memory to cause the terminal to perform the method for determining channel state information (CSI) according to claim 16.
